(19) United States
(12) Patent Application Publication
(10) Pub. No.: US 2020/0130491 A1
(43) Pub. Date: Apr. 30, 2020

(54) SYSTEMS AND METHODS FOR PROVIDING RETRACTABLE COVERS FOR VEHICLES

(71) Applicant: Roger Neuens, Niagara, WI (US)

(72) Inventor: Roger Neuens, Niagara, WI (US)

(21) Appl. No.: 16/173,783

(22) Filed: Oct. 29, 2018

(51) Int. Cl. B60J 11/02

(52) U.S. Cl. CPC B60J 11/02

(57) ABSTRACT

A device for receiving and housing a cover for a vehicle. The device includes an enclosure attachable to the vehicle, which houses the cover therein when the cover is in a retracted state. A roller unit is rotatably coupled to the enclosure. The cover is rolled around the roller unit when in the retracted state. A portion of the cover is not rolled around the roller unit when the cover is in an extended state. A winding device is rotationally biased to roll the cover onto the roller unit. A cover fixation system couples a first end of the cover to the roller unit, the first end remaining coupled to the roller unit when the cover is in the retracted state, the extended state, and intermediate states therebetween. The cover is withdrawn from the enclosure to cover the vehicle by overcoming the bias of the winding device.

### FIELD

The present disclosure generally relates to systems and methods for retractably covering items, and more particularly to systems and methods for retractably covering vehicles with conventional or custom covers receivable by a roller unit that retractably holds the cover thereon.

### BACKGROUND

The Background and Summary are provided to introduce a foundation and selection of concepts that are further described below in the Detailed Description. The Background and Summary are not intended to identify key or essential features of the claimed subject matter, nor are they intended to be used as an aid in limiting the scope of the claimed subject matter.

### SUMMARY

One embodiment of the present disclosure generally relates to a device for receiving and housing a cover for a vehicle. The device includes an enclosure configured to be attached to the vehicle, where the enclosure houses the cover therein when the cover is in a retracted state. A roller unit is rotatably coupled to the enclosure, where the cover is rolled around the roller unit when the cover is in the retracted state, and where at least a portion of the cover is not rolled around the roller unit when the cover is in an extended state. A winding device rotationally biases the roller unit relative to the enclosure so as to roll the cover onto the roller unit. The device includes a cover fixation system for coupling a first end of the cover to the roller unit, where the first end of the cover remains coupled to the roller unit when the cover is in the retracted state, in the extended state, and in intermediate states therebetween. The cover is withdrawn from the enclosure to cover the vehicle by overcoming the bias of the winding device.

Another embodiment generally relates to a system for retractably covering a vehicle. The system includes a cover having a top section with at least two flaps coupled thereto. When the cover is in an extended state, the top section is positioned over a top of the vehicle and the at least two flaps are foldable down from the top section to cover one or more sides of the vehicle. An enclosure is configured to be attached to the vehicle, where the enclosure houses the cover therein when the cover is in a retracted state. A roller unit is rotatably coupled to the enclosure, where the cover is rolled around the roller unit when the cover is in the retracted state, and where at least a portion of the cover is not rolled around the roller unit when the cover is in the extended state. A winding device rotationally biases the roller unit relative to the enclosure to roll the cover onto the roller unit. The cover is withdrawn from the enclosure to cover the vehicle by overcoming the bias of the winding device.

Various other features, objects and advantages of the disclosure will be made apparent from the following description taken together with the drawings.

### BRIEF DESCRIPTION OF THE DRAWINGS

The drawings illustrate embodiments for carrying out the disclosure. The same numbers are used throughout the drawings to reference like features and like components. In the drawings:

FIG. 1 is an isometric view of an all-terrain vehicle (ATV) covered with a tarp in the conventional manner known in the prior art;

FIG. 2 is an isometric view of the same ATV covered using one embodiment of the systems and methods according to the present disclosure;

FIG. 3 is a top view of one embodiment of a system according to the present disclosure;

FIG. 4 is an isometric view of an enclosure for housing a system according to the present disclosure;

FIG. 5 is a sectional view taken along the line A-A of the enclosure of FIG. 4;

FIGS. 6 and 7A are isometric and exploded views of an exemplary roller unit to be incorporated in an enclosure such as is shown in FIG. 4;

FIG. 7B is a sectional side view of an end cap taken along the line B-B in FIG. 7A;

FIG. 8 is a side view of another embodiment of a roller unit according to the present disclosure;

FIG. 9 is a top view of yet another roller unit according to the present disclosure; and

FIGS. 10 and 11 are isometric and top views of a custom cover in an unfolded and folded state to be incorporated into the system presently disclosed.

### DETAILED DISCLOSURE

This written description uses examples to disclose embodiments of the present disclosure and also to enable any person skilled in the art to practice or make and use the same. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The present disclosure generally relates to systems and methods for retractably containing covers for vehicles, whether the custom covers disclosed herein or existing covers owned by a user. For the sake of brevity, the term “vehicles” is used herein to broadly describe a wide variety of object and devices. These include, but are not limited to, cars, trucks, vans, motorcycles, all-terrain vehicles, utility terrain/task vehicles, snowmobiles, watercraft, hobbyist machines and sports equipment, trailers, temporary structures, wood piles, wagons, bicycles, and lawn and farm equipment. The present inventor has identified that the known processes and devices for storing, using, and once again stowing covers (such as tarps) for vehicles, such as all-terrain vehicles (ATVs), is cumbersome and time consuming. For example, an ATV user must walk out to wherever the ATV is kept in a stored state, manually remove the cover, walk the cover back to sheltered storage (such as a garage) before using the ATV. The process must then be repeated in reverse when the user is done for the day. The process further lacks flexibility for parking the vehicle in a new location, or circumstances in which it is desirable to cover the ATV when out and about. For example, the ATV may be driven to a distant location when an unexpected rainstorm arises, leaving the user without a means for covering the ATV in the new location.

Accordingly, the present inventor has identified a need for providing a retractable cover for vehicles that is both easy to use, and keeps the cover with the vehicle intended to be covered.

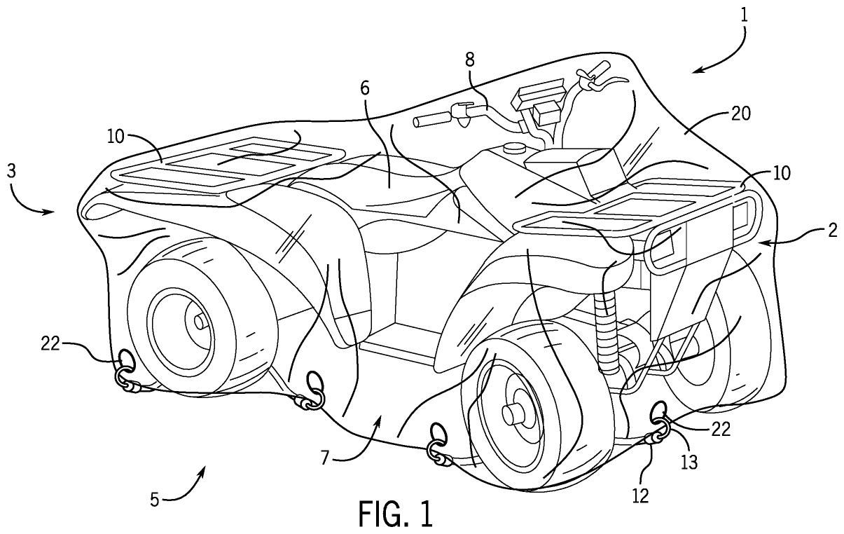

FIG. 1 depicts an exemplary ATV 1 covered with a typical tarp 20 in the conventional manner. The ATV 1 has a front 2 and back 3, left (not numbered) and right 5, and top 6 and bottom 7. Handlebars 8 extend up from the top 6, which in most cases forms the highest point of the ATV 1. The tarp 20, which is customarily a rectangular shape having grommets 22 around the perimeter, is laid over the top 6 of the ATV 1, whereby ropes or bungee cords 12 having hooks 13 may be used to affix the tarp 20 to the ATV 1 to prevent disruption from wind and other elements. The ATV 1 shown has a rack 10 on the back 3, as well as a rack 10 on the front 2, which are each used for carrying accessories in the manner known in the art.

As previously described, using the tarp 20 in the manner shown is cumbersome and time consuming. The tarp 20 and bungee cords 12 must be kept in some secure location when not in use, and the process of covering and uncovering the ATV 1 with the tarp 20 requires time for alignment, folding and unfolding, and the like.

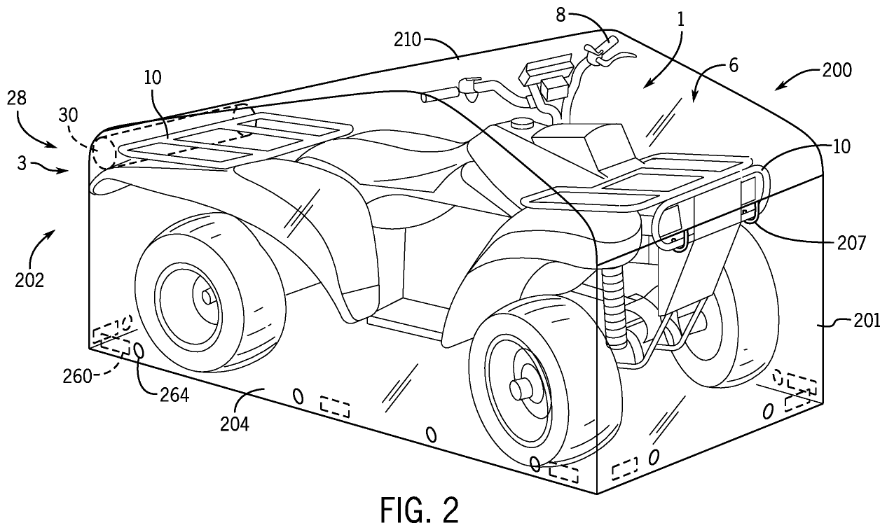

FIG. 2 discloses one embodiment of a system 28 for covering an ATV 1 according to the present disclosure. In the embodiment shown, the ATV 1 is covered by a custom cover 200, though the system 28 may alternatively integrate a typical tarp 20 known in the art. Further description of the custom cover 200, as well as the mechanisms by which the custom cover 200 or a tarp 20 known in the art may be connected to the system 28, are discussed below. In the embodiment shown, the system 28 is removably fixed to the ATV 1 near the back 3, such as behind and/or below the rack 10. The system 28 houses the custom cover 200 in a retracted state such that it does not disrupt use of the rack 10, but is situated to easily install or uninstall the custom cover 200 contained therein.

The custom cover 200, includes a top section 210 that rests on the top 6 of the ATV 1, specifically draping over the handlebars 8, as well as a front 201, back 202, left (not shown), and right 204 that each extend downwardly from the top section 210. In the embodiment shown, the custom cover 200 includes grommets 264 for affixing the custom cover 200 in a conventional manner, as well as retainers 260 to help hold the custom cover 200 in the position shown. In certain embodiments, these retainers 260 are weights sewn into the custom cover 200 to weigh the custom cover 200 down. In other embodiments, these retainers 260 are super magnets sewn in the custom cover 200 and configured to magnetically engage with each other and/or the underlying vehicle, such as the ATV 1. It should be recognized that these exemplary retainers 260 may also be integrated into a tarp 20.

In further embodiments, the tarp 20 or custom cover 200 has an elastic or a drawstring (not shown) within the outer perimeter such that the tarp 20 or custom cover 200 is biased or drawn inwardly to be retained on the vehicle, such as the ATV 1. In certain embodiments, this configuration resembles a fitted bedsheet, allowing the tarp 20 or custom cover to be stretched over the ATV 1 for installation. It should be recognized that other mechanisms for fixing the tarp 20 or custom cover 200 to the ATV 1 are also anticipated by the present disclosure.

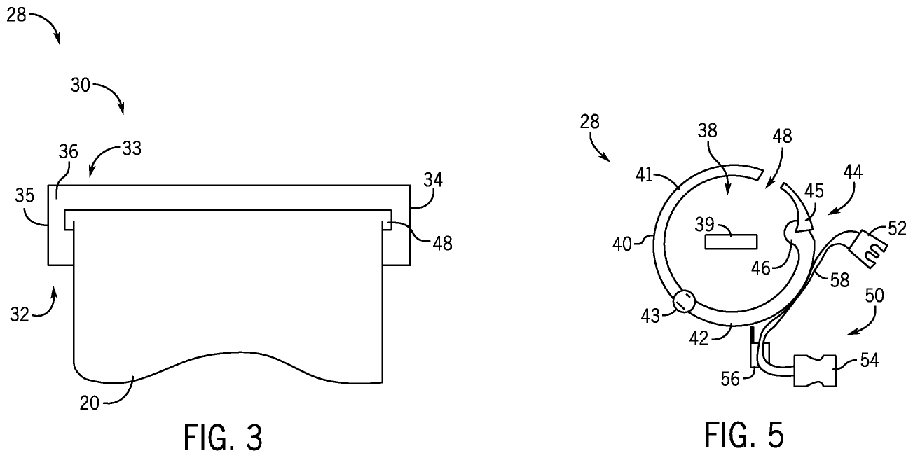

FIG. 3 shows a top down view of the system 28 shown in FIG. 2, now removed from the ATV 1. The system 28 includes an enclosure 30 for containing the components of the system 28 as well as the tarp 20 or custom cover 200, which extend outwardly from the enclosure 30 via a tarp opening 48 defined therein. The enclosure 30 has a front 32 and back 33, left 34 and right 35, and a top 36 that defines the tarp opening 48 previously described.

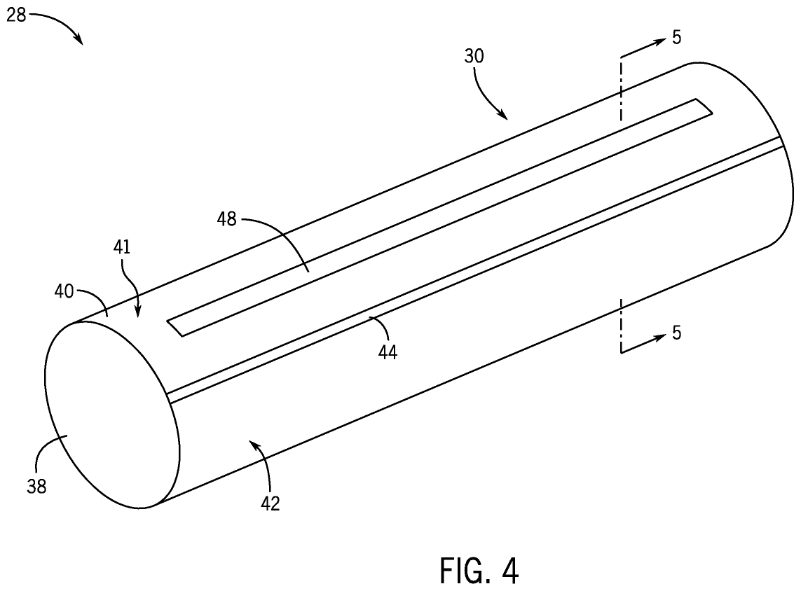

FIG. 4 depicts an isometric view of one embodiment of a system 28 such as is shown in FIG. 3, now with the tarp 20 removed for clarity. As shown, the enclosure 30 further includes ends 38 and has an upper portion 41 and lower portion 42 that are hingably connected by a hinge 43, as shown in the sectional view of FIG. 5. The upper portion 41 and lower portion 42 are releasably coupled in a closed position via a latch 44. The latch 44 includes a tab 45 defined within the upper portion 41 and a receiver 46 for receiving the tab 45, the receiver 46 being defined within the lower portion 42. It should be recognized that alternative mechanisms for the latch 44 are also anticipated by the present disclosure, including alternating the locations of these elements. In this manner, the enclosure 30 is openable by releasing the latch 44 such that the upper portion 41 is rotated open relative to the lower portion 42 to provide access within the enclosure 30.

As shown in FIG. 5, the ends 38 further define roller unit fixation receivers 39, which will be discussed further below. Additionally, the embodiment shown in FIG. 5 discloses one embodiment of coupling hardware 50 for mounting the system 28 to an ATV 1, such as shown in the embodiment of FIG. 2. In the embodiment shown, the coupling hardware 50 includes a coupler 52 that is releasably received within a coupler receiver 54, each being coupled to a strap 58 attached to the enclosure 30. An adjuster 56 is provided for adjustably tightening the strap 58 once the coupler 52 is received within the coupler receiver 54 (i.e., with the strap 58 wrapped around the rack 10). The present disclosure anticipates alternative structures known in the art to be use as the coupling hardware 50, such as threaded fasteners, snaps, or hook and loop fasteners.

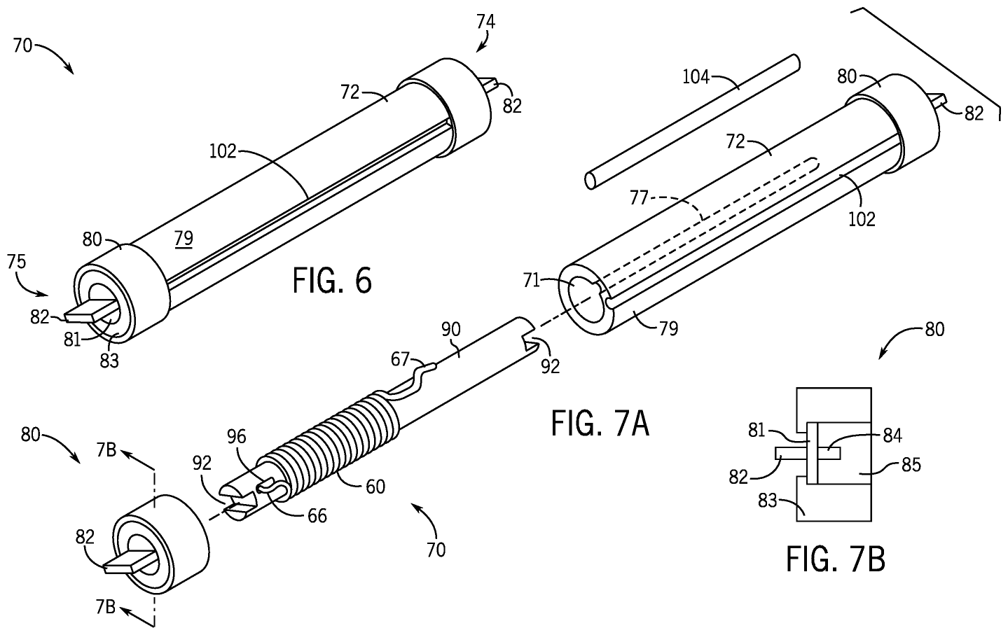

FIGS. 6-7B disclose an exemplary roller unit 70 configured to be received within the enclosure 30, which receives the tarp 20 or custom cover 200 thereon in a rolling, retractable manner. The roller unit 70 includes an outer cylinder 72 having a left 74 and a right 75, as well as an interior (not shown) and exterior 79. An end cap 80 is provided at each of the left 74 and right 75, which includes a fixed portion 81, rotating portion 83, and inner member recess 85, such as is shown in FIG. 7B. The end cap 80 further includes a roller fixation member 82 and an inner member fixation member 84, which in the present embodiment are integrally formed and together constitute the fixed portion 81 of the end cap 80. The roller fixation member 82 is received within the roller unit fixation receiver 39 defined in the ends 38 of the enclosure 30 as shown in FIG. 5 such that the fixed portion 81 of the end cap 80 is non-rotatable relative to the enclosure 30. Similarly, the inner member fixation member 84, which is likewise non-rotatable relative to the enclosure 30, is received within an inner member fixation receiver 92 defined within an inner member 90. The inner member 90 includes a left 94 and a right 95, and is received within the roller unit 70 within an inner member receiver 71 defined therein. An inner member fixation receiver 92 is defined at both a left 94 and right 95 to engage with end caps 80 as previously discussed.

It should be recognized then that the roller unit 70 is rotatable relative to the inner member 90, the inner member 90 being fixed relative to the enclosure 30 by the inner member fixation member 84 and roller fixation member 82. In this manner, the roller unit 70 rotates coaxially relative to the inner member 90.

A winding device 60, such as the spring shown, has an inner member engagement end 66 opposite an outer cylinder engagement end 67. The inner member engagement end 66 is receivable within a spring fixation groove 96 defined within the inner member 90 and the outer cylinder engagement end 67 is received within a spring fixation groove 77 defined within the interior of the outer cylinder 72 of the roller unit 70. The winding device 60 creates a tensioning bias between the roller unit 70 and the inner member 90 when one is rotated relative to the other, based on the spring tension generated by the winding device 60. In this manner, rotating the roller unit 70 in a first direction relative to the inner member 90, such as counter-clockwise, generates a spring force within the winding device 60 to bias the roller unit 70 back in the opposite direction, or clockwise.

The exterior 79 of the roller unit 70 is further configured to be coupled to the tarp 20 or custom cover 200. In the embodiment shown in FIG. 7A, the exterior 79 defines a channel 102 for receiving a portion of the tarp 20 or custom cover 200, whereby an insert 104 is then pressed into the channel 102 to lock the tarp 20 or custom cover 200 within the channel 102. In the embodiment shown, the channel 102 has a substantially circular cross section, and the insert 104 is an elastomeric material that is correspondingly shaped and sized to be received in a tight, press-fit engagement within the channel 102. The relative dimensions are further configured to accommodate the exact, or typical, thickness of the tarp 20 or custom cover 200.

In this manner, the tarp 20 or custom cover 200 may be fixed at a first end to the roller unit 70, whereby the tarp 20 or custom cover 200 may be then wrapped around the roller unit 70 for the remainder of its entire length. From there, the roller unit 70 may be received within the enclosure 30 previously shown in FIG. 4. Once the roller unit 70 is installed within the enclosure 30 by engagement between the end caps 80 and roller unit fixation receivers 39 in the ends 38 of the enclosure 30, the roller unit 70 is pre-tensioned to bias the tarp 20 or custom cover 200 in a retracted state by rotating the roller unit 70 relative to the enclosure 30. For example, if the tarp 20 or custom cover 200 are wrapped about the roller unit 70 such that a clockwise rotation would cause them to unroll, the roller unit 70 may be pre-tensioned by manually rotating the roller unit 70 in the clockwise direction (since the winding device 60 will create a rotating bias in the opposite, or counter-clockwise direction to bias the roller unit 70 in the retractable direction)

Once the roller unit 70 has been pre-tensioned, a small portion of the tarp 20 or custom cover 200 is fed through the tarp opening 48 in the upper portion 41 of the enclosure 30 and the upper portion 41 latched to the lower portion 42 via the latch 44. It should be recognized that the thickness of the portion of the tarp 20 or custom cover 200 extending out of the tarp opening 48 should be thicker than the tarp opening 48, or have some other mechanism for preventing the end from being fully retracted and un-receivable within the enclosure 30.

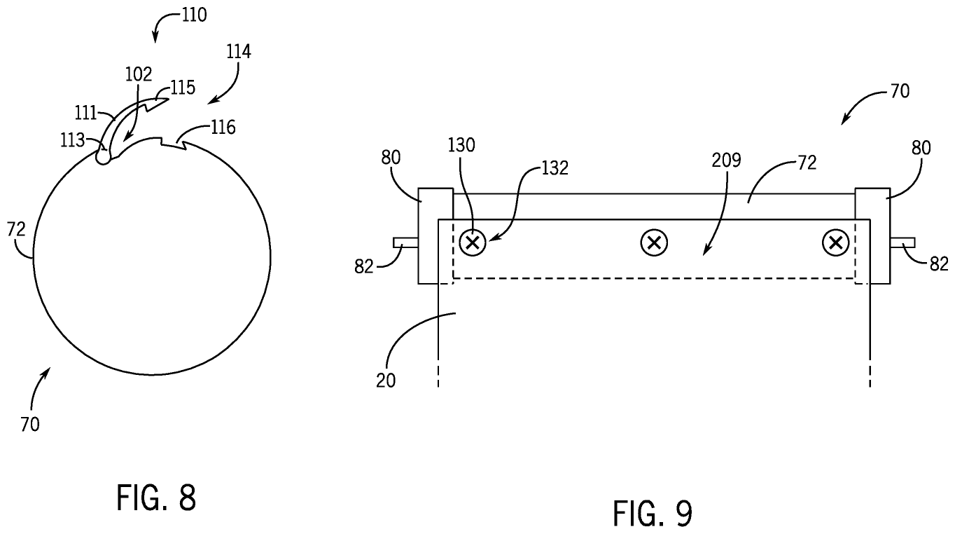

FIGS. 8 and 9 depict alternative embodiments of roller units 70, and particularly the respective mechanisms for fixing the tarp 20 or custom cover 200 to the roller unit 70. In particular, FIG. 8 discloses a clamp 110 for securing the tarp 20 or custom cover 200 to the roller unit 70. A channel 102 is generally defined within the outer cylinder 72 for receiving an end of the tarp 20 or custom cover 200 therein. Once in place, a door 111 that is rotatably coupled to the outer cylinder 72 via a hinge 113 is rotated into the closed position to clamp the tarp 20 or custom cover 200 therein. The door 111 is held in the closed position by a latch 114. In the embodiment shown, the latch 114 includes a tab 115 that is receivable within a receiver 116 defined within the outer cylinder 72 in a press-fit arrangement. However, the present disclosure anticipates other methods for clamping the tarp 20 or custom cover 200 to the roller unit 70.

FIG. 9 discloses another embodiment of roller unit 70, and likewise another method for coupling the tarp 20 or custom cover 200 thereto. In the embodiment shown, the tarp 20 or custom cover 200 are coupled to the roller unit 70 via fasteners 130 inserted therethrough, which are receivable within a fastener receiver 132 defined within the roller unit 70. In the embodiment shown, the fasteners 130 are screws that are received within threaded fastener receivers 132 defined within the outer cylinder 72. In certain embodiments, the method for coupling the tarp 20 or custom cover 200 to the roller unit 70 further includes the placement of a reinforcement bar (not shown) that is sandwiched between the fasteners 130 and the tarp 20 or custom cover 200. This additional reinforcement bar provides for more distributed attachment support between the tarp 20 or custom cover 200 and the roller unit 70. Whether in addition to, or in the alternative to the reinforcement bar previously discussed, the tarp 20 or custom cover 200 itself may include a reinforced region 209 that has either a thicker portion, or is otherwise structurally reinforced to provide further strength when the tarp 20 or custom cover 200 is coupled to the roller unit 70.

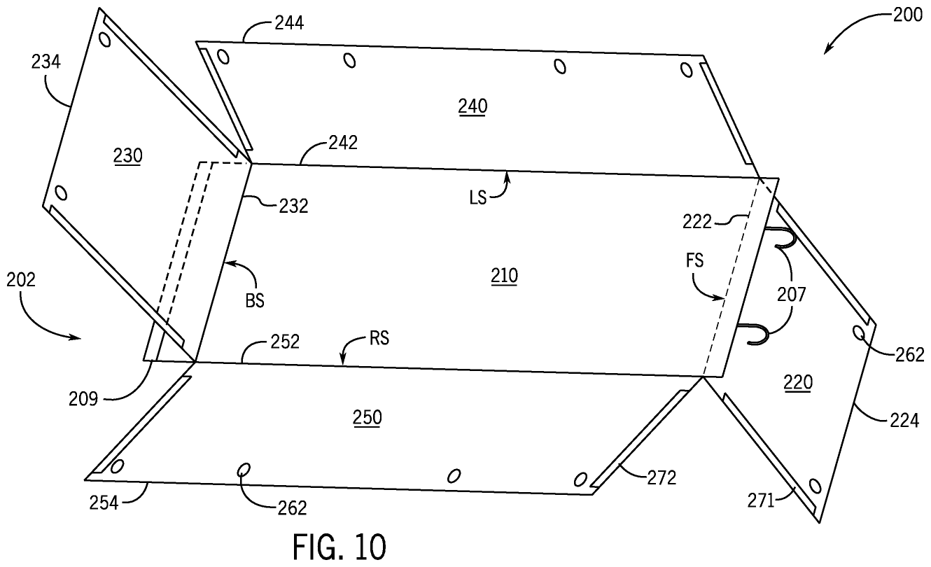

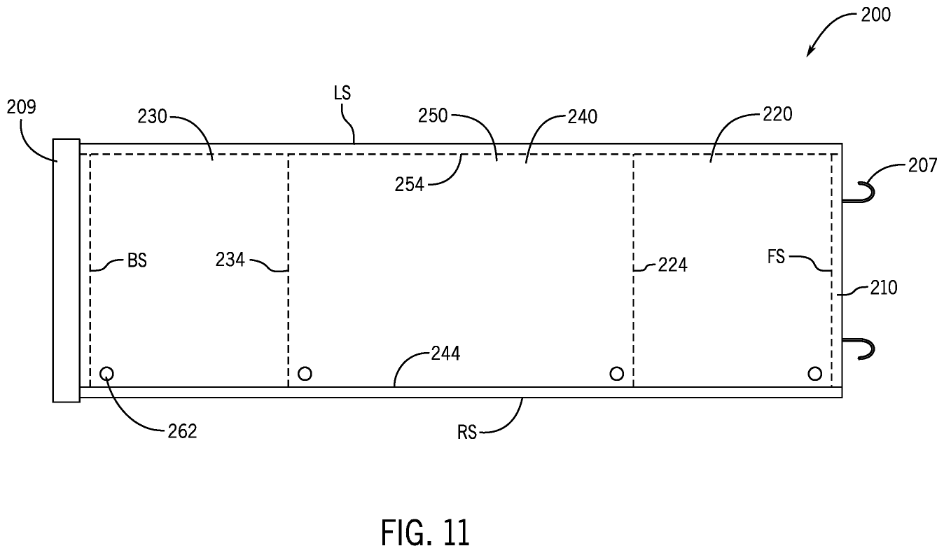

FIGS. 10 and 11 disclose a custom cover 200 configured to be coupled within the system 28 in a manner previously discussed, similar to the embodiment previously shown in FIG. 2. As shown in the embodiment of FIG. 10, the custom cover 200 includes a top section 210, front 201 and back 202, and left 203 and right 204. The respective sections of the present embodiment are attached to the top section 210 via seams, which are defined as the front seam FS, back seam BS, left seam LS, and right seam RS. In this manner, each of the sections has a seam side (222, 232, 242, and 252), as well as opposing free sides (224, 234, 244, and 254). The embodiment shown further incorporates a reinforced region 209 at the back 202, as well as front attachments 207 (shown here as hooks) at the front 201. As previously discussed, the front attachments 207 are configured to be attached to the vehicle itself, such as on the rack 10 at the front 2 of the ATV 1 as shown in FIG. 2.

The embodiment of FIG. 10 further incorporates grommets 264 within the free sides (224, 234, 244, and 254), as well as corresponding attachments 271 and 272 between each of the sections. In the present embodiment, the attachments 271 and 272 are corresponding sides of a hook and loop fastener system, such that the front flap 220 is releasably coupled to the right flap 250 via the attachments 271 and 272 when the custom cover 200 is installed.

FIG. 11 shows the custom cover 200 of FIG. 10 in folded form, allowing the custom cover 200 to fit into the enclosure 30 during retraction. In the embodiment shown, the front flap 220, back flap 230, left flap 240, and right flap 250 are folded onto the top section 210 such that the custom cover 200 in the folded configuration is substantially rectangular. In this configuration, the front attachments 207 may remain coupled to the ATV 1 while the user is folding to prevent the custom cover 200 from retracting into the enclosure 30. Once the custom cover 200 is folded in the manner required, the front attachments 207 may be released from the ATV 1, allowing the system 28 to retract the custom cover 200 into the enclosure 30 by rotation of the roller unit 70 under the bias generated by the winding device 60 as previously discussed.

In the above description, certain terms have been used for brevity, clarity, and understanding. No unnecessary limitations are to be inferred therefrom beyond the requirement of the prior art because such terms are used for descriptive purposes and are intended to be broadly construed. The different assemblies described herein may be used alone or in combination with other devices. It is to be expected that various equivalents, alternatives and modifications are possible within the scope of any appended claims.

I claim:

1. A device for receiving and housing a cover for a vehicle, the device comprising:
an enclosure configured to be attached to the vehicle, wherein the enclosure houses the cover therein when the cover is in a retracted state;
a roller unit that is rotatably coupled to the enclosure, wherein the cover is rolled around the roller unit when the cover is in the retracted state, and wherein at least a portion of the cover is not rolled around the roller unit when the cover is in an extended state;
a winding device that rotationally biases the roller unit relative to the enclosure so as to roll the cover onto the roller unit; and
a cover fixation system for coupling a first end of the cover to the roller unit, wherein the first end of the cover remains coupled to the roller unit when the cover is in the retracted state, in the extended state, and in intermediate states therebetween;
wherein the cover is withdrawn from the enclosure to cover the vehicle by overcoming the bias of the winding device.

2. The device according to claim 1, wherein the cover fixation system comprises a channel defined in the roller unit and an insert configured to be received in the channel, wherein the insert retains the cover within the channel when the insert is received in the channel.

3. The device according to claim 2, wherein the channel and the insert each have a cross section that is substantially circular in shape.

4. The device according to claim 2, wherein the insert is received in the channel in a press-fit arrangement.

5. The device according to claim 1, wherein the cover fixation system comprises fasteners and fastener receivers defined within the roller unit, wherein the cover is coupled to the roller unit by inserting the fasteners through the cover and engaging the fasteners with the fastener receivers

6. The device according to claim 5, wherein the fasteners threadingly engage with the fastener receivers, and wherein the fasteners are configured to be inserted through grommets in the first end of the cover to couple the cover to the roller unit.

7. The device according to claim 1, wherein the enclosure comprises a first portion and a second portion, wherein the first portion and the second portion are separably coupled together such that when separated, access is provided to the roller unit for coupling the cover to the roller unit.

8. The device according to claim 7, wherein the first portion and the second portion are pivotally coupled together, further comprising a latch system for selectively locking the first portion and the second portion in a closed position.

9. The device according to claim 1, wherein the cover has a top section with at least two flaps coupled thereto, wherein when the cover is in the extended state the top section is positioned over a top of the vehicle and the at least two flaps are foldable down from the top section to cover one or more sides of the vehicle.

10. The device according to claim 9, wherein the at least two flaps comprise a front flap configured to cover a front of the vehicle, a back flap configured to cover a back of the vehicle, and left and right flaps configured to cover left and right sides of the vehicle.

11. The device according to claim 10, wherein the front flap of the cover has a seam side that is coupled to the top section and an opposite free side, wherein the cover further comprises an anchoring system that is closer to the free side than to the seam side, and wherein the anchoring system maintains a downward position of the front flap.

12. The device according to claim 11, wherein the anchoring system comprises a grommet sewn within the cover and a tie-down member attached thereto to attaching the free side of the cover to the vehicle.

13. The device according to claim 10, wherein when the back flap is in a downward position, at least a portion of the enclosure is covered by the back flap.

14. The device according to claim 1, wherein the vehicle is an all terrain vehicle (ATV).

15. The device according to claim 1, wherein the enclosure is configured to be attached to a rear of the vehicle such that the vehicle is covered when the cover is withdrawn and attached to a front of the vehicle.

16. The device according to claim 1, wherein the winding device is a coil spring positioned coaxially within the roller unit.

17. A system for retractably covering a vehicle, the system comprising:
a cover having a top section with at least two flaps coupled thereto, wherein when the cover is in an extended state the top section is positioned over a top of the vehicle and the at least two flaps are foldable down from the top section to cover one or more sides of the vehicle;
an enclosure configured to be attached to the vehicle, wherein the enclosure houses the cover therein when the cover is in a retracted state;
a roller unit that is rotatably coupled to the enclosure, wherein the cover is rolled around the roller unit when the cover is in the retracted state, and wherein at least a portion of the cover is not rolled around the roller unit when the cover is in the extended state; and
a winding device that rotationally biases the roller unit relative to the enclosure so as to roll the cover onto the roller unit, wherein the cover is withdrawn from the enclosure to cover the vehicle by overcoming the bias of the winding device.

18. The system according to claim 17, wherein the at least two flaps comprise a front flap configured to cover a front of the vehicle, a back flap configured to cover a back of the vehicle, and left and right flaps configured to cover left and right sides of the vehicle.

19. The system according to claim 18, wherein the front flap of the cover has a seam side that is coupled to the top section and an opposite free side, wherein the cover further comprises an anchoring system that is closer to the free side than to the seam side and wherein the anchoring system maintains a downward position of the front flap, and wherein when the back flap is in a downward position, at least a portion of the enclosure is covered by the back flap.

20. The system according to claim 17, further comprising a cover fixation system for removably coupling a first end of the cover to the roller unit, wherein the first end of the cover remains coupled to the roller unit when the cover is in the retracted state, in the extended state, and in intermediate states therebetween.
